(19) United States
(12) Patent Application Publication
(10) Pub. No.: US 2018/0292604 A1
(43) Pub. Date: Oct. 11, 2018

(54) BEND-INSENSITIVE SINGLE-MODE OPTICAL FIBER FOR FUSED BICONICAL TAPER FIBER OPTIC COUPLER

(71) Applicant: OFS Fitel, LLC, Norcross, GA (US)

(72) Inventors: Kyle Bedard, Sturbridge, MA (US); Lei Huang, Unionville, CT (US); Jie Li, Unionville, CT (US); Mei Wen, Longmeadow, MA (US)

(73) Assignee: OFS Fitel, LLC, Norcross, GA (US)

(21) Appl. No.: 15/942,486

(22) Filed: Mar. 31, 2018

Related U.S. Application Data
(60) Provisional application No. 62/484,039, filed on Apr. 11, 2017.

(51) Int. Cl. G02B 6/02; G02B 6/28; G02B 6/036; H01S 3/094

(52) U.S. Cl. CPC G02B 6/02042; G02B 6/2856; H01S 3/094007; G02B 6/02333; G02B 6/03633

(57) ABSTRACT

Embodiments are directed to a single mode optical fiber. The optical fiber comprises, from the center to the periphery: a central core having a first refractive index, a pedestal region having a second refractive index, a trench region having a third refractive index, and a cladding region having a fourth refractive index. The third refractive index is less than the second refractive index.

### CROSS-REFERENCE TO RELATED APPLICATIONS

This application claims priority to U.S. Provisional Patent Application Ser. No. 62/484,039, filed Apr. 11, 2017, which is hereby incorporated by reference in its entirety.

### BACKGROUND

The embodiments described herein relate in general to the field of fiber optics. More specifically, the embodiments described herein relate to biconical taper fiber couplers.

Optical fibers have been used in communication systems to transmit information. Optical fibers sometimes need to be coupled together such that one or more input optical fibers can be coupled to one or more output optical fibers. Biconical taper fiber optical couplers are one form of couplers used in the art. One method used to produce biconical couplers involves heating them in a region where they are bunched or twisted with the heated region being in longitudinal tension.

Small form factor (SFF) devices, such as an erbium doped fiber amplifier (EDFA) can use fibers that have bends. It has been found that some forms of fiber are sensitive to bending of the fiber. For example, some fibers exhibit a significant loss when bent—as much as 13 dB of attenuation with a 12 mm bend diameter at the operating wavelength, while the desired loss is approximately 0.5 dB. Traditional methods of reducing bend sensitivity involves adding one or more layers of glass surrounding the fiber core. However, added bend insensitivity features can present difficulties where coupler fabrication is concerned.

### SUMMARY

Embodiments are directed to a single mode optical fiber. The optical fiber comprises, from the center to the periphery: a central core having a first refractive index, a pedestal region having a second refractive index, a trench region having a third refractive index, and a cladding region having a fourth refractive index. The third refractive index is less than the second refractive index.

Additional features and advantages are realized through techniques described herein. Other embodiments and aspects are described in detail herein. For a better understanding, refer to the description and to the drawings.

### BRIEF DESCRIPTION OF THE DRAWINGS

The subject matter which is regarded as embodiments is particularly pointed out and distinctly claimed in the claims at the conclusion of the specification. The foregoing and other features and advantages of the embodiments are apparent from the following detailed description taken in conjunction with the accompanying drawings in which:

FIG. 1 is a cross-section of an exemplary optical fiber;

FIG. 2 is an illustration of a fiber undergoing a tapering process;

FIG. 3 is a graph illustrating effective indices of modes propagating within a typical bend-insensitive single mode fiber;

FIG. 4 is a graph illustrating the refractive index of various regions of one or more embodiments;

FIG. 5 is a graph illustrating a effective indices of modes propagating within one or more embodiments; and

FIG. 6 is a cross-section of an exemplary optical fiber.

### DETAILED DESCRIPTION

Various embodiments of the present invention will now be described with reference to the related drawings. Alternate embodiments can be devised without departing from the scope of this invention. Various connections might be set forth between elements in the following description and in the drawings. These connections, unless specified otherwise, can be direct or indirect, and the present description is not intended to be limiting in this respect. Accordingly, a coupling of entities can refer to either a direct or an indirect connection.

A single-mode optical fiber has a relatively small core region and a relatively large cladding region that has a lower index of refraction than the core region. The result is a fiber that has only one electromagnetic mode that is transmitted with low loss. A single-mode fiber typically has a large bandwidth and low dispersion.

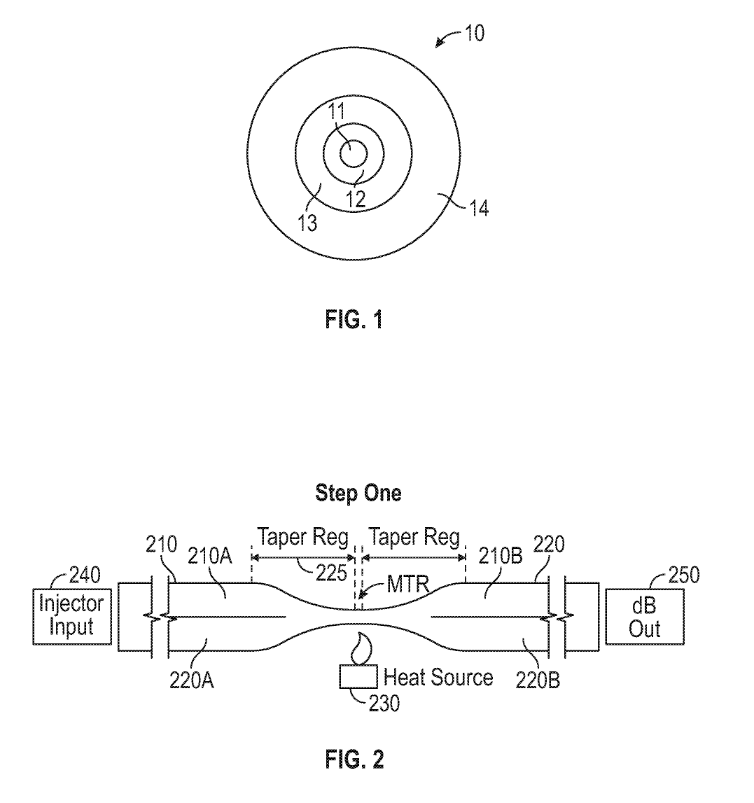

FIG. 1 shows cross-section of an exemplary optical fiber 10. It should be understood that FIG. 1 is not to scale. The optical fiber is made up of various regions of transparent material generally distributed with axial symmetry around the center axis of the fiber. The different regions can be defined by their index of refraction, which need not be consistent within the region. Optical fiber 10 is made up of a core region 11 with a first refraction index. Surrounding core region 11 is a first cladding region 12 with a second refraction index. The first cladding region 12 is surrounded by a trench region 13 with a third refraction index. Trench region 13 is surrounded by a second cladding region 14 with a fourth refraction index. Other layers, including a glass coating, a buffer tube, a strength member, an inner jacket, an outer jacket, and the like, an also be present, but are not illustrated in FIG. 1. Such layers do not affect the propagation properties of optical fiber 10.

Some embodiments include a trench 106 that has a refractive index difference nₜ with respect to outer cladding 108. This refractive index difference nₜ may be a function of radius r where r corresponds to the radial position with respect to the center of the optical fiber. In some embodiments, the refractive index of the trench 106 is lower than that of the cladding region. In such an embodiment, the purpose of trench 106 is to make the optical fiber less sensitive to bending. Other regions, such as a coating, a buffer tube, a strength member, an inner jacket, an outer jacket, and the like, can also be present, but are not illustrated in FIG. 1.

When using optical fiber, it is sometimes desirable to couple together two or more fibers. As an example, with reference to FIG. 2, two fibers undergoing a tapering process are presented. Two fibers are placed in an apparatus. The fibers are heated using a heat source 230 and placed in tension. In this manner, two fibers are fused together while the fibers are pulled to form a biconical tapered region 225. The two fibers are tapered until the desired coupling ratios are achieved. Light is injected into one fiber using injector input 240 and the optical power is monitored at output 250. While only a first and second fiber are shown in FIG. 2, it should be understood that multiple fibers can be present on either side of the taper.

With reference now once again to the FIG. 2, two fibers 210 and 220 (labelled 210A and 220A at the first end and labelled 210B and 220B at the second end) are placed in tension at an effective elevated temperature to be fused together while the fibers are extended to form the biconical tapered region 225. During the extension under tension the elevated temperature facilitates fusing to form the biconical tapered region 225.

Resulting from the typical fiber tapering process, the mode field diameter (MFD) of the fundamental mode propagating within the fiber core expands gradually into the cladding as the original core decreases in diameter during the heating and stretching process. Eventually the original core (such as core 102) disappears and the mode will propagate in the original cladding (such as cladding 104) as the new core is surrounded by air as the new cladding of the resulting waveguide.

A low-loss transition of light energy between the original core mode to the new core mode is desired to ensure the coupler's performance. The effective index of the fundamental mode should be sufficiently higher than the effective index for next higher order modes with the same symmetry to avoid mode coupling or energy loss while the fundamental mode is propagating through the taper.

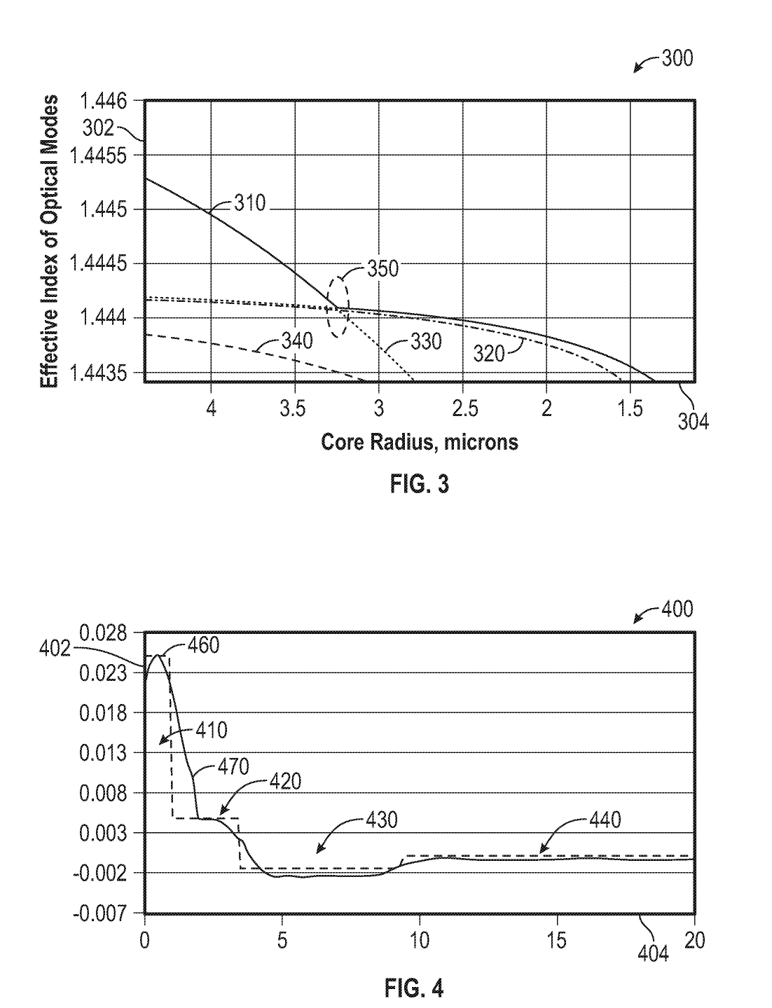

It has been found that there can be an undesirable mode coupling condition that can be present in traditional bend-insensitive fibers (such as the one illustrated in FIG. 1). With reference to FIG. 3, a simulation of effective indices of optical modes propagating within an optical fiber as a solution for Maxwell's equations is presented. Graph 300 represents the solution for a bend-insensitive fiber with a trench design that is operating at 1550 nm. Y-axis 302 represents the effective indices of optical modes. X-axis 304 represents the radius of the core. Line 310 is the fundamental mode, line 320 is the LP₁₁ mode, line 330 is the LP₀₂ mode, and line 340 is the LP₀₃ mode. Circle 350 shows that, as the fiber is tapered, at a certain radius, the effective indices of the fundamental mode 310, LP₁₁ mode 320, and LP₀₂ mode 330 become too close to each other, thus resulting a phase-matching condition that leads to coupling together fundamental modes 310 to LP₀₂ mode 330. The result is that the fundamental mode loses energy to LP₀₂ mode 330. This signal loss renders the fiber less useful.

In some embodiments, a solution is to use an annular core pedestal region that has a refractive index that is lower than the core index, but is higher than the cladding index and trench index. With reference to FIG. 4, an exemplary refractive index profile of one or more embodiments is presented. Conventionally, the distance, r, to the center of the optical fiber is shown on the x-axis 404, and the difference between the refractive index (at radius r) and the refractive index of the cladding is shown on the y-axis 402. Dashed line 460 represents an ideal refractive index while solid line 470 represents an actual refractive index of an exemplary embodiment.

As shown in FIG. 4, there are four regions in one or more embodiments. There is a core region 410 with a first refractive index. There is a pedestal region 420 with a second refractive index that is lower than the first refractive index. There is a trench region 430 with a third refractive index that is lower than the second refractive index. And there is a cladding region 440 with a fourth refractive index. In some embodiments, the fourth refractive index has a magnitude between that of the third refractive index and the second refractive index.

In an embodiment, the core region 410 has a radius of 0.5 to 3 micrometers. The pedestal region 420 has a radius of 1 to 9 micrometers. The trench region 430 has a radius of 3 to 45 micrometers.

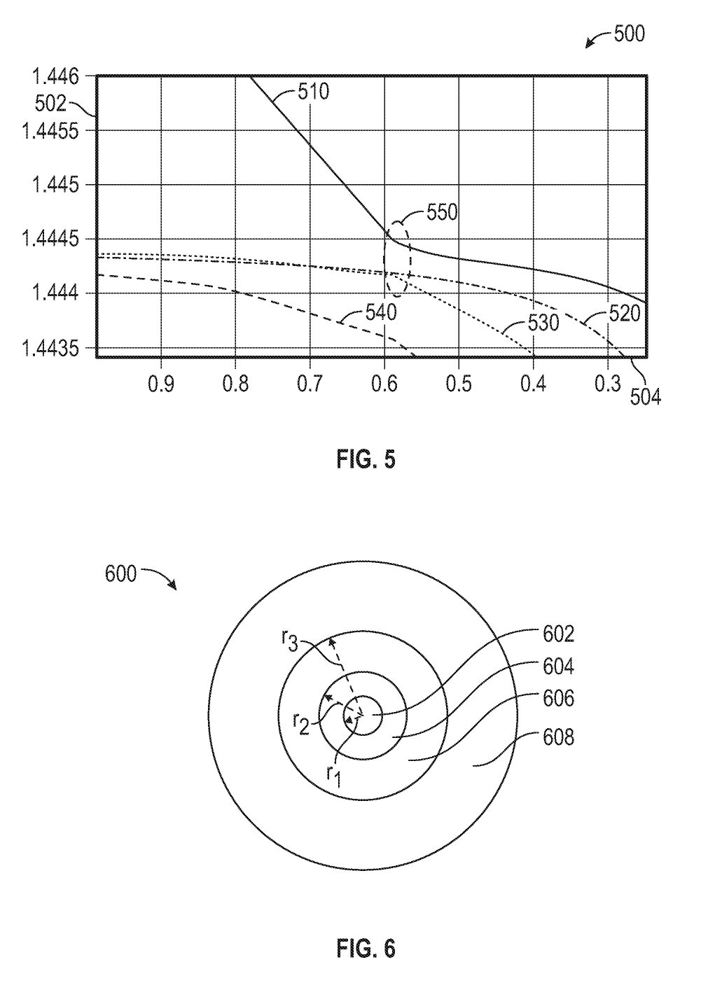

With reference to FIG. 5, a simulation of effective indices of optical modes propagating within an optical fiber as a solution for Maxwell's equations is presented. Graph 500 represents the solution for a bend-insensitive fiber with the design shown in FIG. 4 that is operating at 1550 nm. Y-axis 502 represents the effective index of optical modes. X-axis 504 represents the radius of the core. Line 510 is the fundamental mode, line 520 is the LP₁₁ mode, line 530 is the LP₀₂ mode, and line 540 is the LP₀₃ mode.

In contrast to graph 200 of FIG. 2, it can be seen that fundamental mode 510 and LP₀₂ mode 530 do not cross each other. Even at the closest distance (represented by circle 550), there is still a difference. In one simulation, the difference is approximately 3.229×10⁻⁴. This value is sufficiently large to efficiently avoid coupling between fundamental mode 410 and LP₀₂ mode 430 during tapering. The result is less signal loss during the tapering process. This ensures a smooth mode transition during fused biconical-taper optical coupler manufacturing.

In addition, the pedestal region lessens the MFD reduction and increase in cutoff wavelength due to the trench, while increasing the inner core refractive index. The pedestal region also minimizes coupling between the fundamental mode and higher order modes during the tapering process. In some embodiments, one or more trenches are designed to improve bend-insensitivity, thus providing an improved coupler fiber supporting a trend toward smaller optical componentry.

FIG. 6 shows cross-section of an exemplary optical fiber 600. It should be understood that FIG. 6 is not to scale. Optical fiber 600 has a central core 602. The core region 102 is contactingly surrounded by one or more regions of relatively low refractive index. These regions can include a pedestal region 604 that generally has a constant index profile. Surrounding pedestal region 604 is a trench region 606. Pedestal region 604 has a higher refractive index than does trench region 606 and cladding region 608. Surrounding the trench region 606 is a cladding region 608. Other regions, such as a coating, a buffer tube, a strength member, an inner jacket, an outer jacket, and the like, can also be present, but are not illustrated in FIG. 6.

In summary, a novel coupler fiber design is proposed to increase fiber bend-insensitivity while ensuring a smooth mode transition during fused biconical-taper coupler manufacturing. Simulation results show significantly improved bend-insensitivity as compared to commercially available coupler fiber and high NA coupler fiber, mainly attributable to carefully optimized trench regions within the coupler fiber design. A novel pedestal region is added to minimize the possible coupling between fundamental mode and leaky higher mode during the tapering process, as well as to maintain the MFD.

The fiber of embodiments of the present invention can be manufactured by drawing from a preform using one of a variety of different methods. In some embodiments, a modified chemical vapor deposition (MCVD) technique is used. Other techniques, such as chemical vapor deposition (CVD), outside vapor deposition (OVD), plasma enhanced chemical vapor deposition (PCVD), vapor axial deposition (VAD), or any combination thereof also can be used.

In some embodiments, a fiber be a bend-optimized, single-mode fiber that is bandwidth optimized at 1550 nm. In some embodiments, the core fiber is a silica glass that is doped with GeO₂ and/or P₂O₅ to raise the refractive index of the core, while the pedestal region and the cladding region are made from silica with no doping. In some embodiments, the pedestal region and cladding region are doped with a different amount of GeO₂ from the core region and a different amount of doping from each other, to adjust the refractive index of those regions.

In some embodiments, the trench region may be doped with fluorine to lower the refractive index of the trench below that of the pedestal region. In other embodiments, the core is made from silica with no dopants, while the pedestal region, trench region, and cladding region are doped with differing amounts of fluorine to lower the refractive index of the pedestal, trench, and cladding with respect to the core.

Testing of prototypes reveals a marked improvement in regards to attenuation during bending. Operating at 1550 nm, for a bend radius of 5 mm, a traditional coupler fiber has attenuation of greater than 13 dB. A high numerical aperture (NA) fiber has an attenuation of 1.31 dB. A prototype using embodiments described herein has an attenuation of only 0.197 dB. For a bend radius of 7.5 mm, a high NA fiber has an attenuation of 0.168 dB. A prototype using embodiments described herein has an attenuation of only 0.04 dB.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The descriptions presented herein are for purposes of illustration and description, but is not intended to be exhaustive or limited. Many modifications and variations will be apparent to those of ordinary skill in the art without departing from the scope and spirit of embodiments of the invention. The embodiment was chosen and described in order to best explain the principles of operation and the practical application, and to enable others of ordinary skill in the art to understand embodiments of the present invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A single mode optical fiber, comprising from the center to the periphery:
a central core having a first refractive index;
a pedestal region having a second refractive index;
a trench region having a third refractive index; and
a cladding region having a fourth refractive index; wherein:
the third refractive index is less than the second refractive index.

2. The single mode optical fiber of claim 1, wherein the first refractive index is greater than the second refractive index.

3. The single mode optical fiber of claim 2, wherein the second refractive index is chosen to minimize bending loss.

4. The single mode optical fiber of claim 1, wherein the fourth refractive index is greater than the third refractive index.

5. The single mode optical fiber of claim 4, wherein the third refractive index is chosen to minimize bending loss.

6. The single mode optical fiber of claim 1, wherein the fourth refractive index is less than the second refractive index.

7. The single mode optical fiber of claim 1, wherein the central core comprises a silica doped with germanium.

8. The single mode optical fiber of claim 1, wherein the trench region comprises a silica with no dopant.

9. The single mode optical fiber of claim 8, wherein the pedestal region comprises a silica doped with germanium such that the second refractive index is higher than the third refractive index and lower than the first refractive index.

10. The single mode optical fiber of claim 8, wherein the cladding region comprises a silica doped with germanium such that the fourth refractive index is higher than the third refractive index and lower than the second refractive index.

11. The single mode optical fiber of claim 1, wherein the central core comprises a silica with no dopant.

12. The single mode optical fiber of claim 11, wherein the pedestal region comprises a silica doped with fluorine to lower the second refractive index lower than the first refractive index.

13. The single mode optical fiber of claim 12, wherein the trench region comprises a silica doped with fluorine to lower the third refractive index lower than the second refractive index.

14. The single mode optical fiber of claim 1, wherein the cladding region comprises a silica doped with fluorine.

15. The single mode optical fiber of claim 1, wherein:
the second refractive index is chosen to minimize coupling between a fundamental mode and higher order modes during creation of a fused biconical-taper optical coupler.

16. The single mode optical fiber of claim 1, wherein the fiber is made using a method selected from the group consisting of CVD, OVD, MCVD, PCVD, VAD, and any combination thereof.
